(19) United States
(12) Patent Application Publication
(10) Pub. No.: US 2016/0358233 A1
(43) Pub. Date: Dec. 8, 2016

(54) SYSTEM AND METHOD FOR MERCHANT INCENTIVE DONATION SCRIP CARD

(71) Applicants: Barry Pidgeon, Salem, OH (US); Brooke Pidgeon, Homeworth, OH (US)

(72) Inventors: Barry Pidgeon, Salem, OH (US); Brooke Pidgeon, Homeworth, OH (US)

(21) Appl. No.: 15/176,273

(22) Filed: Jun. 8, 2016

Related U.S. Application Data
(60) Provisional application No. 62/172,310, filed on Jun. 8, 2015.

(51) Int. Cl. G06Q 30/02; G06Q 20/10; G06Q 20/34

(52) U.S. Cl. CPC G06Q 30/0279; G06Q 20/354; G06Q 20/3552; G06Q 20/105

(57) ABSTRACT

A donation added value merchant incentive card system that defines a methodology for generating charitable donations through an organization authorization scrip card. The system allows pre-selected cardholders to load and reload monetary funds into a card associated account through multiple venues for use in participating card name merchants for payments of goods and services therewith. A pre-determined percentage based on the card's loaded value as an incentive, which is received from the merchant, is paid to the charitable card issuer and then paid to the card associated entity, in this example a non-profit organization, leaving the user's scrip card value intact for use with the merchant.

This application claims the benefit of U.S. Provisional Application Ser. No. 62/172,310, filed Jun. 8, 2015.

### BACKGROUND OF THE INVENTION

1. Technical Field

This invention relates generally to the field of monetary transfer, and more specifically to a loadable store value card instrument that provides a portion of the value to a fundraising beneficiary.

2. Description of Prior Art

Charitable giving provides a funding avenue for individuals to financially aid a variety of service-oriented organizations. A variety of charitable fundraising methods and systems have been developed to utilize integrated automatic donations tied to charitable gift cards and the like. Examples of such systems can be seen in U.S. Pat. Nos. 6,581,041, 5,621,640, U.S. Publications 2004/0182922, 2005/0261931, 2009/0283587, 2010/0211500 and 2013/0254106.

In U.S. Pat. Nos. 6,581,041 and 5621,640 the systems are directed to methods of charitable giving and investing and automatic philanthropic contributions systems.

U.S. Publication 2004/018922 discloses a system of loadable store value cards with a portion of card value deducted to benefit a fundraising organization. U.S. Publication 2005/0261931 discloses a system of prepaid gift cards sold when a portion of the moneys collected is kept by the fundraiser with the remaining proceeds returned to the program coordinator.

U.S. Publication 2009/0283587 claims a charitable gift giving system wherein a gift card is purchased and a donation amount is deducted from the card. U.S. Publication 2010/0211500 is directed to a charitable gift card wherein a giver, through the card, give a person a gift and a donation to charities simultaneously.

Finally in U.S. Publication 2013/0254106 the method is illustrated to purchase a gift card and make a donation using a computer to establish two accounts, one for the online merchant and a second for distribution to a charity for the value of the gift card.

### SUMMARY OF THE INVENTION

A system to issue value added merchandise cards that can be used to purchase goods and services from card designated merchants through a service organization, such as a church. The scrip cards are keyed to an account wherein the full value of the card is redeemable through the vendor with donations made to the church from the incentive received from the vendor, based on an agreed upon donation percentage. The scrip cards are obtained through the church's association with a scrip card provider that manages and enables funds transfer and card distribution. The scrip cards are activated through multiple access portals with value amounts added from user direct transfer of funds electronically through an enabling card management platform, maintained by the scrip card provider through interlocking agreements with merchants, non-profits and card users.

### DESCRIPTION OF THE DRAWINGS

FIG. 1 is a block flow diagram of the scrip card system of the invention.

FIG. 2 is a block flow diagram of the fundraising distribution associated with the scrip card system of the invention.

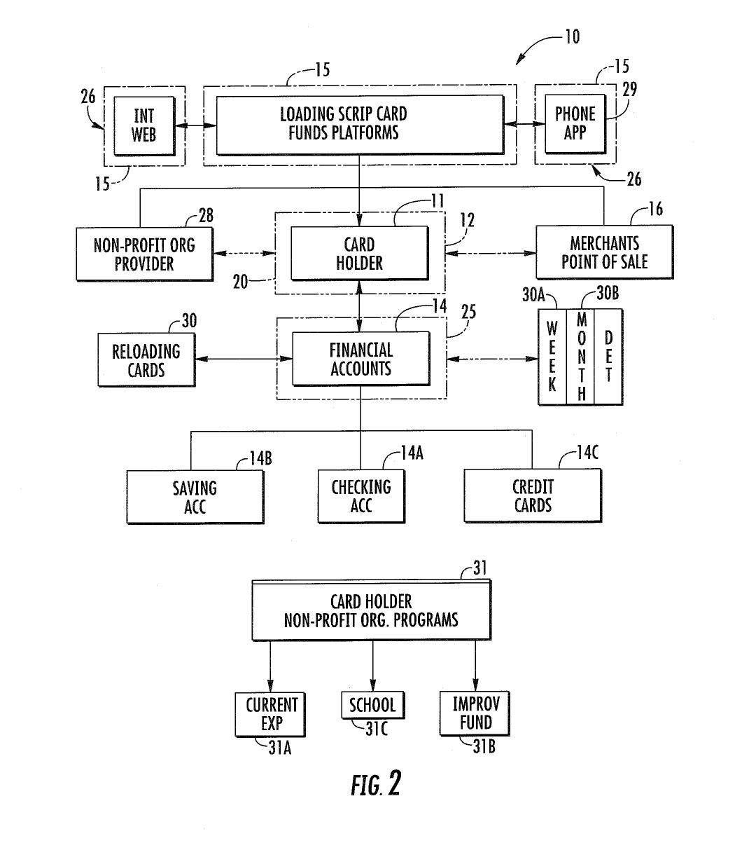

### DESCRIPTION OF THE PREFERRED EMBODIMENT

A donation added scrip card method and system 10 of the invention that provides a registered cardholder 11 a store value scrip card 12 that the cardholder 11 can selectively add monetary funds 13 from their personal financial accounts 14 through a secure account management website 15. An account associated with the scrip card 12 is set up for each cardholder to enable fund transfer and tracking data. The fund loaded card may be used to pay for goods and services at the merchants 16 defined with the scrip card 12 predetermined percentage distribution based on the card's monetary value is directed to card member's organization, in this example a church or non-profit 17, and purchasing credits to the merchant 16 leaving the cardholder 11 full access use of the card's loaded funds.

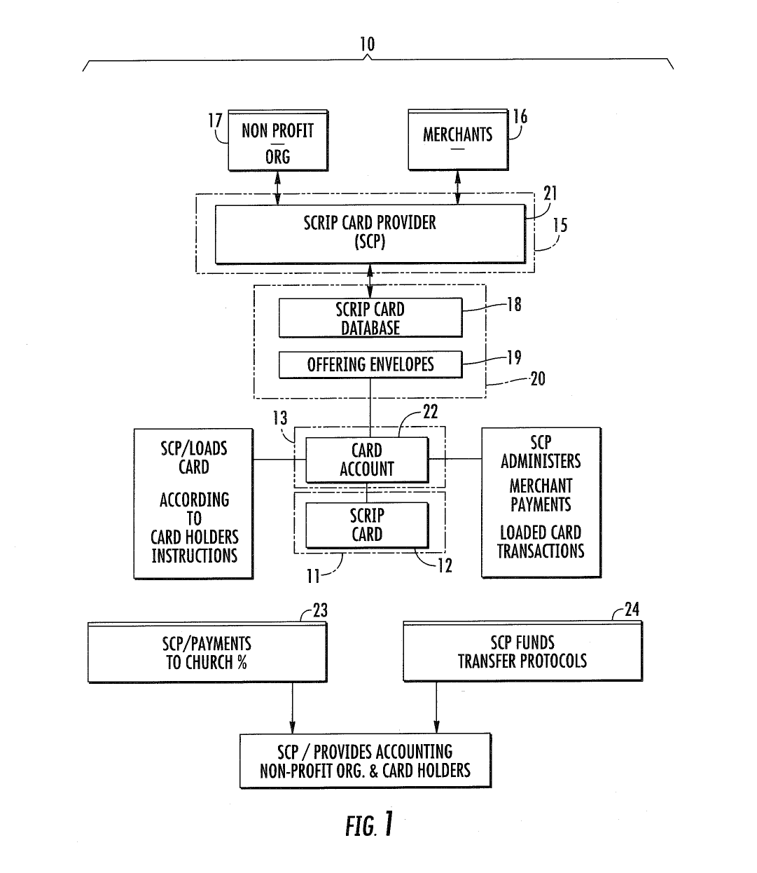

Referring to FIG. 1 of the drawings, a block flow diagram can be seen illustrating the basic method steps of the scrip card system 10 of the invention. In this example, cardholders 11 are selected from church members ID number (offering envelope no.), which are determined and accessed through an existing donation database 18 by distribution of offering envelopes 19, which have an individual keyed registration number 20 associated offering envelope no. therewith. It will be evident that other ID registration avenues may be used, such as Social Security or other personal sequential identification numbers assigned to the card.

A scrip card provider 21 provides registration, distribution and administers the scrip cards 12 by creating a user's card account 22 and database records for the organization issued cardholders 11. The scrip card provider enters into agreements with card directed merchandiser 16 and cardholder organizations (in this example the non-profit 17) with a determined donation percentage 23 and distribution of funds to the non-profit organization 17.

Card directed merchandisers 16 agreements with the scrip card provider 21 provides named merchant participation and authorization to accept and recognize store value scrip cards 12 linked to the card member's organization and optionally to sign up cardholder.

The scrip card provider 21 card system management provides the platform to activate the scrip card 12 online by providing funds transfer protocols 24 with financial institutions 25 that hold and transfer funds for the card account holders. Fund transfers (loading scrip cards 12) from cardholders' financial accounts 14 include but are limited to checking accounts 14A, savings accounts 14B, and personal credit cards 14C. The card issuer (scrip card provider 21) therefore enables transfers to the scrip card 12 according to cardholder instruction by multiple access portals, including direct online website access 26 and supported phone apps 27.

Third party authorization account access is also provided, by example the non-profit business manager 28 who would help in accessing and loading of the scrip cards 12 and associated incentive rewards by random distribution at the church, as will be described in greater detail hereinafter. Scrip card value loading (funds transferred) can also be obtained from the scrip card provider 21 and may also be available at point of use through the merchandiser 16.

Funds accountability is based on determined fund source flow. Funds are transferred from card member's 11 financial accounts 14 as noted, to load the scrip cards 12. In this example, the merchandiser 16 receives 95% of the transferred funds. The participant organization (non-profit organization 17) receives, in this example, 5% of the transferred funds. The scrip card value obtained (purchasing value) is the full 100% of the transferred amounts originally authorized by the cardholders. The non-profit organization directed funds, 5%, moves through the scrip card provider 21 management accounts, which may draw a service fee percentage, depending on the agreement protocols enabled by the church participation.

Availability of automatic repetitive fund transfer to the scrip cards 12 may utilize the same access venues as used to set up the initial fund transfers, utilizing the established cardholder's associated accounts 14. Direct user fund transfer 30 (reloading of the card) can also be accomplished by predetermined scheduling for incremental reoccurring transfers on a weekly 30A, monthly 30B, or whatever time sequence to be determined by the cardholder.

The scrip card 10 of the invention provides for the scrip card provider 21 to maintain and direct funds with a financial authorization. All funds directed to and held by the financial institution 25 after which the scrip card provider 21 distributes to the agreed to incentive percentage 23 to the church 18 and the purchasing credits (funds) to the authorized merchandiser 16 associated with the scrip card 12 designated by the agreement with the scrip card provider 21, which provides exclusivity with the church 18 and merchandiser 16.

This oversight provides and enables accountability of the funds transfer to the participating churches 18, thereby supplying the churches 17 with individual accumulative monthly amounts for each cardholder 11 (church member) as transferred in a reporting system to church financial management.

Scrip card provider 21 distributes the scrip cards 12, in this example by mailing to each non-profit organization member and provides in addition to online access help as noted, a phone hotline 29 to help cardholders 11 and assist them in all aspects of the scrip card use, as hereinbefore described.

Part of the system to encourage members to sign up for scrip card 12 would be a recorded message from pastor of the church.

The amounts of the funds transferred to the scrip card 12 may be protected by specific dollar amounts, in value increasing increments, for example $25, $50, $100, $150 in fifty dollar increments up to $600. This gives the cardholder 11 a structured predetermined amounts to work with and may simplify accountability overall within the system. Given that the ability to access by authorized users, the scrip card provider 21 is generally unlimited, the scrip card 12 can be, as noted, easily reloaded to maintain for example a useable balance, much like a bank debit card, with the added incentive that each transfer by the cardholder 11 will benefit the card member's non-profit organization 17.

Card use incentives may be offered, for example, wherein cardholder's pin number is entered into a drawing each month, or alternately a cardholder may be rewarded based on the most funds transferred (money credits) to win a gift card to the merchant at the end of the month.

The merchant's incentive donation scrip card system 10 of the invention relies on the established funds management online platform of the scrip card provider 21, who provides the fundraising platform for the church or non-profit organization varied levels of services available. Non-profit organizations that sign onto the full services, as hereinbefore described, are provided with discounts as opposed to those who have elected to use only some of the available services associated with the system. Such sign-up programs 31 can stipulate where the funds go, as in this example, current expenses 31A, improvement fund 31B or school 31C; other such selections can be determined.

It will thus be seen that a new and novel system and method for merchandise incentive donation base scrip cards has been illustrated and described, so as to provide an integrated funds management system to combine a merchandising value base inclusive scrip card with an online fundraising venue for non-profit organizations by an enabled online management platform combined with the exclusivity of specific merchandisers and non-profit organizations that avail themselves of the system advantages for fundraising, as outlined above.

It will be evident to those skilled in the art that various changes and modifications may be made thereto without departing from the spirit of the invention.

Therefore, I claim:

1. A method for facilitating fundraising donations via script card in a funds platform for a plurality of select members of a beneficiary organization by funds loading of said script cards with member stated value being usable by the member when purchasing goods and services from store select vendors, by associating the script card with the account within which funds of members may be stored, withdrawn and replenished in response to member request,
placing individual member's funds with a first value,
providing a second value of fundraising beneficiaries from member cards associated funds account.

2. The method set forth in claim 1 wherein the second value provided to specific fundraising beneficiary equals a predetermined percentage of the first loaded card value associated with store value card of first member.

3. The method set forth in claim 1 wherein the card fund platform comprises,
a script card provider, a script card database, fund determination offering venues, a merchant and beneficiary payment administrator and a financial account holder.

4. The method set forth in claim 1 wherein the specific fundraising beneficiary comprises,
a non-profit religious organization.

5. The method set forth in claim 1 wherein the specified fundraising beneficiary comprises,
a non-profit school.

6. The method set forth in claim 1 wherein replacing funds comprises,
receiving additional funds from said script members via multiple venue input.

7. The method set forth in claim 1 wherein a request received from a script card member comprises,
receiving a communication from said script card member via multiple communication venues, including, but not limited to,
a secure website, voice communication, data input, text telecommunication via multiple mobile and fixed communication devices.

8. The method set forth in claim 1 wherein said financial account holder comprises,
an independent commercial financial institution through which script card provider distributes the agreed percentage determined by member beneficiary exclusivity.
